(19) United States
(12) Patent Application Publication
(10) Pub. No.: US 2016/0295849 A1
(43) Pub. Date: Oct. 13, 2016

(54) Game Call Apparatus

(71) Applicant: Nathan Heegaard, Minneapolis, MN (US)

(72) Inventor: Nathan Heegaard, Minneapolis, MN (US)

(21) Appl. No.: 15/092,130

(22) Filed: Apr. 6, 2016

Related U.S. Application Data
(60) Provisional application No. 62/143,852, filed on Apr. 7, 2015.

(51) Int. Cl. A01M 31/00

(52) U.S. Cl. CPC A01M 31/004

(57) ABSTRACT

The present invention provides a game call apparatus that includes a main tube body, a first bellows adapter, a second bellows adapter, a bellows tube body, a first internal bellows, a second internal bellows, a ball, and a sound-making apparatus. The present invention also provides a game call apparatus with multiple game callers that includes a first body, a valve, two second bodies and two sound-making apparatuses. Methods of calling game are also provided.

### RELATED APPLICATIONS

This application claims priority to U.S. Provisional Patent Application Ser. No. 62/143,852 filed Apr. 7, 2015, which is hereby incorporated by reference in its entirety for all purposes.

### BACKGROUND OF THE INVENTION

Hunting and birding often require the use of specific game calls to locate and attract the desired animal or bird.

To effectively blow a duck call, for example, takes a lot of practice. Attaining the right sound requires training the caller's mouth, lips, tongue, throat, lungs, and core to produce the correct amount of air and pressure through just the right size opening in your mouth in order to get the reed to vibrate and thereby produce the sound of a live duck. Blowing a duck call also requires maintaining the correct positioning of one's hands over the call to control the amount of air that is released, and to muzzle or extrude the sound in various ways.

Every avid water fowler knows the seven basic types of call including, for example, the feeder call, the basic quack, the greeting call, the comeback call, the hail call, the lonesome hen call, and the drake whistle call. The feeder call is one of the most difficult calls to perform, but it also one of the most effective calls when out in the blind. It requires one to move the back of one's tongue up and down at an extremely fast speed in order to make the reed vibrate rapidly, all the while maintaining correct air pressure. Because of the difficulty in performing this maneuver, many people cannot do the call successfully. Therefore, there is a strong need for an alternative method of producing this sound, without using an electronic device.

What is needed is a simple, easy to operate, and ergonomically designed hand-operated game caller.

### SUMMARY OF THE INVENTION

The present invention provides a game call apparatus that includes a main tube body, a first bellows adapter, a second bellows adapter, a bellows tube body, a first internal bellows, a second internal bellows, a ball, and a sound-making apparatus. Methods of calling game with the game call apparatus are also provided.

The game call apparatus has the following advantages. First, the game call apparatus is much smaller and more compact than the competitors (see, e.g., the Pete Rickard Scotch Duck Shaker Call and the Primos Feeding Mailer Shaker Duck Call). Second, the game call apparatus produces a game call by simply jerking the call to bounce the balls between much smaller bellows instead of the sound being produced by vigorously shaking a long wobbly bellow, as is necessary with the competitions' devices. Third, the game call apparatus is less visible when out in the blind. Fourth, the game call apparatus has unique interchangeability—as one can use the same call with many different kinds of sound makers/reeds or inserts (waterfowl and small/large game). Finally, anyone can use the game call apparatus.

The present invention also provides a game call apparatus with multiple game callers that includes a first body, a valve, two second bodies and two sound-making apparatuses. Methods of calling game with the game call apparatus with multiple game callers are also provided.

The game call apparatus with multiple game callers has the following advantages. First, the game call apparatus with multiple game callers can perform many different types of calls (i.e. sounds) from two types of game. Second, unlike prior art designs, the game call apparatus with multiple game callers has a single air-intake channel instead of separate air-intake channels, thereby simplifying the design and manufacture of the device. Finally, the game call apparatus' unique valve allows the user to choose, at a moments notice, which particular caller they desire to use by rotating the valve to direct airflow into one caller or the other, or into both at the same time allowing sound to come out of both callers simultaneously (unlike any other game call).

The present invention provides a game call apparatus. The game call apparatus includes: a main tube body having a proximal end, a distal end, and one or more exhaust ports each independently between the proximal end and the distal end; a first bellows adapter having a first face, a second face, a first main bore, and a first outer edge, wherein the first main bore of the first bellows adapter is coupled to the proximal end of the main tube body; a second bellows adapter having a first face, a second face, a second main bore, and a second outer edge, wherein the second main bore of the second bellows adapter is coupled to the distal end of the main tube body; a bellows tube body having a proximal end and a distal end, wherein the proximal end of the bellows tube body is coupled to the first outer edge of the first bellows adapter, wherein the proximal end of the bellows tube body is coupled to the second outer edge of the second bellows adapter, a first internal bellows having an open proximal end and a closed distal end, wherein the open proximal end of the first internal bellows is coupled to the proximal end of the main tube body and contained within the bellows tube body, a second internal bellows having an open proximal end and a closed distal end, wherein the open proximal end of the second internal bellows is coupled to the distal end of the main tube body and contained within the bellows tube body; one or more balls, wherein the one or more balls are contained within the bellows tube body in between the closed distal end of the first internal bellows and the closed distal end of the second internal bellows; one or more sound-making apparatuses each independently in fluid communication with the one or more exhaust ports, wherein the one or more sound-making apparatuses each independently produces a game call in response to a passage of air caused by a movement of the one or more balls against the closed distal end of the first internal bellows, the closed distal end of the second internal bellows, or a combination thereof, and wherein the passage of air causes the one or more sound-making apparatuses each independently to vibrate.

In one embodiment, the game call apparatus is used to call waterfowl, upland game, small game, big game or a combination thereof. In one embodiment, the main tube body is tubular. In one embodiment, the exhaust port is tubular.

In one embodiment, the first bellows adapter is pressure fitted into the bellows tube body. In one embodiment, the first main bore is centered on the first bellows adapter. In one embodiment, the game call apparatus further includes one or more first secondary bores located around the first main bore of the first bellows adapter. In one embodiment, the one or more first secondary bores are each symmetrically located around the first main bore.

In one embodiment, the second bellows adapter is pressure fitted into the bellows tube body. In one embodiment, the second main bore is centered on the second bellows adapter. In one embodiment, the game call apparatus further includes one or more second secondary bores located around the second main bore of the second bellows adapter. In one embodiment, the one or more second secondary bores are each symmetrically located around the second main bore.

In one embodiment, the bellows tube body is tubular. In one embodiment, the first internal bellows includes a resilient flexible material. In one embodiment, the first internal bellows includes a spring in contact with an interior side of the first internal bellows. In one embodiment, the first internal bellows includes one or more first convolutions. In one embodiment, the second internal bellows includes a resilient flexible material. In one embodiment, the second internal bellows includes a spring in contact with an interior side of the second internal bellows. In one embodiment, the second internal bellows includes one or more second convolutions.

In one embodiment, the one or more balls each independently include one or more rigid materials. In one embodiment, the one or more sound-making apparatuses each independently comprise an insert body, a tone or sound board, a cork or wedge, and one or more reeds or discs. In one embodiment, the sound-making apparatus is pressure fitted into the exhaust port.

In one embodiment, the main tube body and the bellows tube body each independently include one or more plastic materials, one or more wood materials, one or more composite materials, one or more metals, or a combination thereof.

In one embodiment, the game call apparatus further includes a second exhaust port between the proximal end and the distal end of the main tube body. In one embodiment, the game call apparatus further includes second sound-making apparatus is in fluid communication with the exhaust port. In one embodiment, the game call apparatus further includes second sound-making apparatus includes a tone or sound board, a cork or wedge, and one or more reeds or discs.

The present invention provides a game call apparatus. The game call apparatus includes: a main tubular body having a proximal end, a distal end, and an exhaust port between the proximal end and the distal end; a first bellows adapter having a first face, a second face, a first main bore centered on the first bellows adapter, one or more first secondary bores each symmetrically located around the first main bore, and an first outer edge, wherein the first main bore of the first bellows adapter is coupled to the proximal end of the main tubular body; a second bellows adapter having a first face, a second face, a second main bore centered on the second bellows adapter, one or more second secondary bores each symmetrically located around the second main bore, and a second outer edge, wherein the second main bore of the second bellows adapter is coupled to the distal end of the main tubular body; a bellows tubular body having a proximal end and a distal end, wherein the proximal end of the bellows tubular body is coupled to the first outer edge of the first bellows adapter, wherein the proximal end of the bellows tubular body is coupled to the second outer edge of the second bellows adapter, a first internal bellows having an open proximal end and a closed distal end, wherein the open proximal end of the first internal bellows is coupled to the proximal end of the main tubular body and contained within the bellows tubular body; a second internal bellows having an open proximal end and a closed distal end, wherein the open proximal end of the second internal bellows is coupled to the distal end of the main tubular body and contained within the bellows tubular body; one or more balls, wherein the one or more balls are contained within the bellows tubular body in between the closed distal end of the first internal bellows and the closed distal end of the second internal bellows; a sound-making apparatus in fluid communication with the exhaust port, wherein the sound-making apparatus includes an insert body, atone or sound board, a cork or wedge, and one or more reeds or discs, wherein the sound-making apparatus produces a game call in response to a passage of air caused by a movement of the one or more balls against the closed distal end of the first internal bellows, the closed distal end of the second internal bellows, or a combination thereof, and wherein the passage of air causes the sound-making apparatus to vibrate.

The present invention provides a game call apparatus. The game call apparatus includes: a main tubular body having a proximal end, a distal end, and an exhaust port between the proximal end and the distal end; a first bellows adapter having a first face, a second face, a first main bore centered on the first bellows adapter, one or more first secondary bores each symmetrically located around the first main bore, and an first outer edge, wherein the first main bore of the first bellows adapter is coupled to the proximal end of the main tubular body; a second bellows adapter having a first face, a second face, a second main bore centered on the second bellows adapter, one or more second secondary bores each symmetrically located around the second main bore, and a second outer edge, wherein the second main bore of the second bellows adapter is coupled to the distal end of the main tubular body; a bellows tubular body having a proximal end and a distal end, wherein the proximal end of the bellows tubular body is coupled to the first outer edge of the first bellows adapter, wherein the proximal end of the bellows tubular body is coupled to the second outer edge of the second bellows adapter, a first internal bellows having an open proximal end and a closed distal end, wherein the open proximal end of the first internal bellows is coupled to the proximal end of the main tubular body and contained within the bellows tubular body, wherein the first internal bellows includes a spring in contact with an interior side of the first internal bellows; a second internal bellows having an open proximal end and a closed distal end, wherein the open proximal end of the second internal bellows is coupled to the distal end of the main tubular body and contained within the bellows tubular body, wherein the second internal bellows includes a spring in contact with an interior side of the second internal bellows; one or more balls, wherein the one or more balls are contained within the bellows tubular body in between the closed distal end of the first internal bellows and the closed distal end of the second internal bellows; and a sound-making apparatus in fluid communication with the exhaust port, wherein the sound-making apparatus includes an insert body, a tone or sound board, a cork or wedge, and one or more reeds or discs, wherein the sound-making apparatus produces a game call in response to a passage of air caused by a movement of the one or more balls against the closed distal end of the first internal bellows, the closed distal end of the second internal bellows, or a combination thereof, and wherein the passage of air causes the sound-making apparatus to vibrate.

The present invention provides a game call apparatus. The game call apparatus includes: a main tube body having a proximal end, a distal end, and an exhaust port between the proximal end and the distal end; a first bellows adapter having a first face, a second face, a first main bore, and an first outer edge, wherein the first main bore of the first bellows adapter is coupled to the proximal end of the main tube body; a second bellows adapter having a first face, a second face, a second main bore, and a second outer edge, wherein the second main bore of the second bellows adapter is coupled to the distal end of the main tube body; a bellows tube body having a proximal end and a distal end, wherein the proximal end of the bellows tube body is coupled to the first outer edge of the first bellows adapter, wherein the proximal end of the bellows tube body is coupled to the second outer edge of the second bellows adapter, a first internal bellows having an open proximal end and a closed distal end, wherein the open proximal end of the first internal bellows is coupled to the proximal end of the main tube body and contained within the bellows tube body, a second internal bellows having an open proximal end and a closed distal end, wherein the open proximal end of the second internal bellows is coupled to the distal end of the main tube body and contained within the bellows tube body; one or more balls, wherein the one or more balls are contained within the bellows tube body in between the closed distal end of the first internal bellows and the closed distal end of the second internal bellows; a second tube body in fluid communication with the exhaust port, wherein the second tube body includes: a first body having a proximal end, a distal end, and an interior opening between the proximal end and the distal end; a valve contained within the first body and extending through the interior opening; two or more second bodies each having a proximal end, a distal end, and a second exhaust port at each distal end, wherein the proximal end of each of the two or more second bodies is each independently coupled to and in fluid communication with the distal end of the first body, wherein the valve directs a passage of air between the two or more second bodies, wherein the second exhaust port of each of the two or more second bodies is each independently in fluid communication with one or more sound-making apparatuses, wherein the one or more sound-making apparatuses each independently include an insert body, a tone or sound board, a cork or wedge, and one or more reeds or discs, and wherein one or more sound-making apparatuses each independently produce one or more game calls in response to the passage of air, which causes the one or more sound-making apparatuses to vibrate.

The present invention also provides a game call apparatus with multiple game callers. The game call apparatus includes: a first body having a proximal end, a distal end, and an interior opening between the proximal end and the distal end; a valve contained within the first body and extending through the interior opening; two or more second bodies each having a proximal end, a distal end, and an exhaust port at each distal end, wherein the proximal end of each of the two or more second bodies is each independently coupled to and in fluid communication with the distal end of the first body, wherein the valve directs a passage of air between the two or more second bodies, wherein the exhaust port of each of the two or more second bodies is each independently in fluid communication with one or more sound-making apparatuses, and wherein one or more sound-making apparatuses each independently produce one or more game calls in response to the passage of air, which causes the one or more sound-making apparatuses to vibrate.

In one embodiment, the game call apparatus is used to call waterfowl, upland game, small game, big game or a combination thereof. In one embodiment, the first body is tubular. In one embodiment, the two or more second bodies are tubular. In one embodiment, the exhaust port is tubular.

In one embodiment, the one or more sound-making apparatuses each independently include an insert body, a tone or sound board, a cork or wedge, and one or more reeds or discs. In one embodiment, the game call apparatus further includes a mouthpiece coupled to the proximal end of the first body.

The present invention provides a game call apparatus with multiple game callers. The game call apparatus includes: a first body having a proximal end, a distal end, and an interior opening between the proximal end and the distal end; a valve contained within the first body and extending through the interior opening; two or more second bodies each having a proximal end, a distal end, and an exhaust port at each distal end, wherein the proximal end of each of the two or more second bodies is each independently coupled to and in fluid communication with the distal end of the first body, wherein the valve directs a passage of air between the two or more second bodies, wherein the exhaust port of each of the two or more second bodies is each independently in fluid communication with one or more sound-making apparatuses, wherein the one or more sound-making apparatuses each independently include an insert body, atone or sound board, a cork or wedge, and one or more reeds or discs, and wherein one or more sound-making apparatuses each independently produce one or more game calls in response to the passage of air, which causes the one or more sound-making apparatuses to vibrate.

The present invention also provides a method of calling game The method includes: providing a game calling apparatus comprising: a main tube body having a proximal end, a distal end, and an exhaust port between the proximal end and the distal end; a first bellows adapter having a first face, a second face, a first main bore, and an first outer edge, wherein the first main bore of the first bellows adapter is coupled to the proximal end of the main tube body; a second bellows adapter having a first face, a second face, a second main bore, and a second outer edge, wherein the second main bore of the second bellows adapter is coupled to the distal end of the main tube body; a bellows tube body having a proximal end and a distal end, wherein the proximal end of the bellows tube body is coupled to the first outer edge of the first bellows adapter, wherein the proximal end of the bellows tube body is coupled to the second outer edge of the second bellows adapter, a first internal bellows having an open proximal end and a closed distal end, wherein the open proximal end of the first internal bellows is coupled to the proximal end of the main tube body and contained within the bellows tube body, a second internal bellows having an open proximal end and a closed distal end, wherein the open proximal end of the second internal bellows is coupled to the distal end of the main tube body and contained within the bellows tube body; one or more balls, wherein the one or more balls are contained within the bellows tube body in between the closed distal end of the first internal bellows and the closed distal end of the second internal bellows; a sound-making apparatus in fluid communication with the exhaust port, wherein the sound-making apparatus produces a game call in response to a passage of air caused by a movement of the one or more balls against the closed distal end of the first internal bellows, the closed distal end of the second internal bellows, or a combination thereof, and wherein the passage of air causes the sound-making apparatus to vibrate; and moving the game calling apparatus.

The present invention also provides a method of calling multiple species of game. The method includes: providing a game call apparatus with multiple game callers comprising: a first body having a proximal end, a distal end, and an interior opening between the proximal end and the distal end; a valve contained within the first body and extending through the interior opening; two or more second bodies each having a proximal end, a distal end, and an exhaust port at each distal end, wherein the proximal end of each of the two or more second bodies is each independently coupled to and in fluid communication with the distal end of the first body, wherein the valve directs a passage of air between the two or more second bodies, wherein the exhaust port of each of the two or more second bodies is each independently in fluid communication with one or more sound-making apparatuses, wherein one or more sound apparatuses each independently produce one or more game calls in response to the passage of air, which causes the one or more sound-making apparatuses to vibrate; and blowing air through the game call apparatus with multiple game callers.

### BRIEF DESCRIPTION OF THE DRAWINGS

Embodiments of the invention may be best understood by referring to the following description and accompanying drawings, which illustrate such embodiments. In the drawings:

FIG. 1 is a perspective front-view drawing illustrating an exemplary game call apparatus.

FIG. 2 is a perspective side-view drawing illustrating an exemplary game call apparatus.

FIG. 3 is a perspective side-view drawing illustrating an exemplary game call apparatus.

FIG. 4 is a perspective top-view drawing illustrating an exemplary game call apparatus.

FIG. 5 is a perspective bottom-view drawing illustrating an exemplary game call apparatus.

FIG. 6 is a perspective front-view drawing illustrating an exemplary bellows adapter.

FIG. 7 is a perspective top-view drawing illustrating an exemplary bellows adapter.

FIG. 8 is a perspective side-view drawing illustrating an exemplary bellows adapter.

FIG. 9 is a perspective bottom-view drawing illustrating an exemplary bellows adapter.

FIG. 10 is a perspective front-view drawing illustrating an exemplary internal bellows.

FIG. 11 is a perspective side-view drawing illustrating an exemplary internal bellows.

FIG. 12 is a perspective front-view drawing illustrating an exemplary game call apparatus with multiple game callers.

FIG. 13 is a perspective front-view drawing illustrating an exploded exemplary game call apparatus with multiple game callers.

FIG. 14 is a perspective side-view drawing illustrating an exemplary game call apparatus without the multiple game callers.

FIG. 15 is a perspective side-view drawing illustrating an exemplary game call apparatus without the multiple game callers.

FIG. 16 is a perspective front-view drawing illustrating an exemplary sound-making apparatus.

FIG. 17 is a perspective top-view drawing illustrating an exemplary sound-making apparatus.

FIG. 18 is a perspective bottom-view drawing illustrating an exemplary sound-making apparatus.

FIG. 19 is a perspective front-view drawing illustrating an exemplary sound-making apparatus.

FIG. 20 is a perspective front-view drawing illustrating an exemplary sound-making apparatus.

FIG. 21 is a perspective side-view drawing illustrating an exemplary game call apparatus with multiple game callers.

FIG. 22 is a perspective side-view drawing illustrating an exemplary second tube body.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

The present invention provides a game call apparatus that includes a main tube body, a first bellows adapter, a second bellows adapter, a bellows tube body, a first internal bellows, a second internal bellows, a ball, and a sound-making apparatus. The present invention also provides a game call apparatus that includes a first body, a valve, two second bodies and two sound-making apparatuses. Methods of calling game are also provided.

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

The referenced items are provided solely for their disclosure prior to the filing date of the present application. Nothing herein is to be construed as an admission that the present invention is not entitled to antedate such material by virtue of prior invention.

Unless otherwise indicated, the words and phrases presented in this document have their ordinary meanings to one of skill in the art. Such ordinary meanings can be obtained by reference to their use in the art and by reference to general and scientific dictionaries, for example, Webster's Third New International Dictionary, Merriam-Webster Inc., Springfield, Mass., 1993 and The American Heritage Dictionary of the English Language, Houghton Mifflin, Boston Mass., 1981.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or of the items with which this term is associated.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “comprising” or “comprises” is intended to mean that the compositions and methods include the recited elements, but not excluding others.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may he removable or releasable in nature.

As used herein, the phrase “game call apparatus” refers to a device that is used to attract game to the user. There are several general categories of game call including, for example, (1) waterfowl (e.g., birds that migrate) including, for example, ducks with more than 40 species each having its own call, geese, cranes, swans, snipe, coots, mud hens, and the like), (2) upland game (e.g., birds and other animals that do not migrate) including, for example, turkey, pheasant, grouse, squirrel, and the like, (3) big game including, for example, deer, elk, caribou, moose, bear, and large cats such as mountain lions, cougars, lynx, and the like.

As used herein, the term “call” refers to any sound that attracts a particular game animal. These calls can include, for example, a duck call, a goose call, a turkey call, and the like. That mimic the various sounds that a game animal may make such as a feeding call, a greeting call, a warning call, a come-back call, and the like. Each type of wild game will have its own specific sounds. As a result, hunters have created various types of “calls” to replicate these sounds. Many calls use some kind of explosion or burst of air to create the sound. Other calls use friction or scraping sounds to create the sounds. Typically, each type of call has different parts. For example, most duck and goose calls have five basic parts including: a barrel, an insert, a tone board or sound board, a cork or wedge, and reeds or discs. Game animals typically make various noises including clicks, clucks, quacks, grunts, grumbles, gobbles, squeals, whistles, yelps, or combinations thereof.

As used herein, the phrase “operatively coupled” refers to bringing two or more items together or into relationship with each other such that they may operate together or allow transfer of information between the two or more items.

As used herein, the terms “include,” “for example,” “such as,” and the like are used illustratively and are not intended to limit the present invention.

As used herein, the terms “preferred” and “preferably” refer to embodiments of the invention that may afford certain benefits, wider certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the term “proximal” refers to the closest end of an object. In contrast, the term “distal” refers to the farthest end of an object.

As used herein, the terms “front,” “back,” “rear,” “upper,” “lower,” “right,” and “left” in this description are merely used to identify the various elements as they are oriented in the FIGS, with “front,” “back,” and “rear” being relative apparatus. These terms are not meant to link the element which they describe, as the various elements may be oriented differently in various applications.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The invention illustratively disclosed herein suitably may be practiced in the absence of any element which is not specifically disclosed herein.

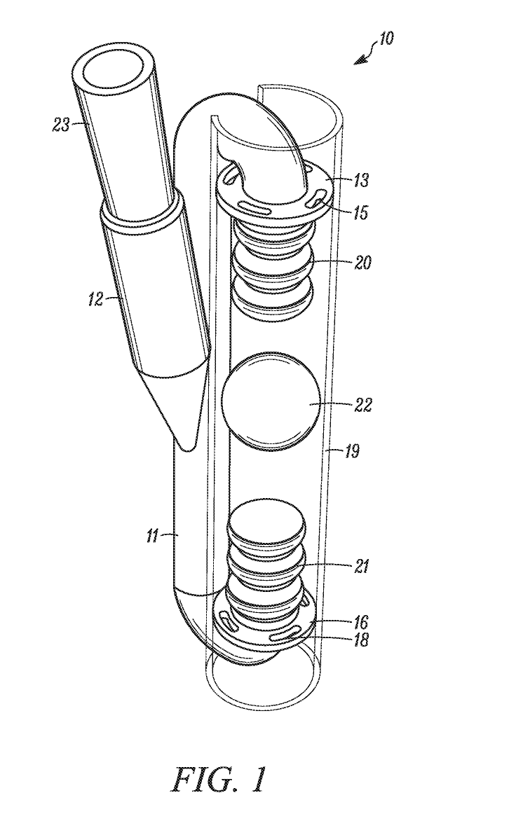

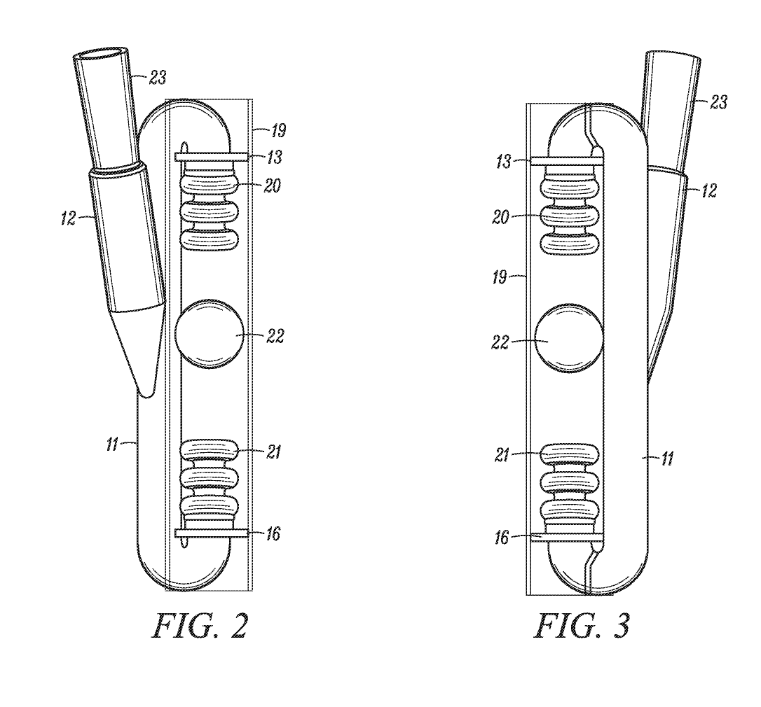

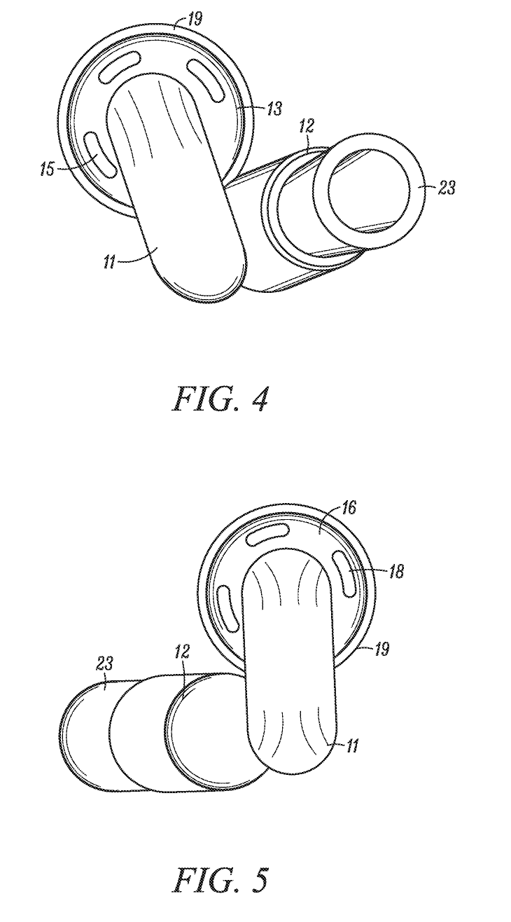

FIGS. 1-5 are various perspective view drawings illustrating an exemplary game call apparatus 10. The game call apparatus 10 includes a main tube body 11, a first bellows adapter 13, a second bellows adapter 16, a bellows tube body 19, a first internal bellows 20, a second internal bellows 21, a ball 22, and a sound-making apparatus 23. The main tube body 11 has a proximal end, a distal end, and an exhaust port 12 between the proximal end and the distal end. The first bellows adapter 13 has a first face, a second face, a first main bore (not shown), and a first outer edge. The first main bore (not shown) of the first bellows adapter 13 is coupled to the proximal end of the main tube body 11. The second bellows adapter 16 has a first face, a second face, a second main bore (not shown), and a second outer edge. The second main bore (not shown) of the second bellows adapter 16 is coupled to the distal end of the main tube body 11. The bellows tube body 19 has a proximal end and a distal end. The proximal end of the bellows tube body 19 is coupled to the first outer edge of the first bellows adapter 13. The proximal end of the bellows tube body 19 is coupled to the second outer edge of the second bellows adapter 16. The first internal bellows 20 has an open proximal end and a closed distal end. The open proximal end of the first internal bellows 20 is coupled to the proximal end of the main tube body 11 and contained within the bellows tube body 19. The second internal bellows 21 has an open proximal end and a closed distal end. The open proximal end of the second internal bellows 21 is coupled to the distal end of the main tube body 11 and contained within the bellows tube body 19. The ball 22 is contained within the bellows tube body 19 in between the closed distal end of the first internal bellows 20 and the closed distal end of the second internal bellows 21. The sound-making apparatus 23 is in fluid communication with the exhaust port 12. The sound-making apparatus 23 produces a game call in response to a passage of air caused by a movement of the ball 22 against the closed distal end of the first internal bellows 20, the closed distal end of the second internal bellows 21, or a combination thereof, and the passage of air causes the sound-making apparatus 23 to vibrate.

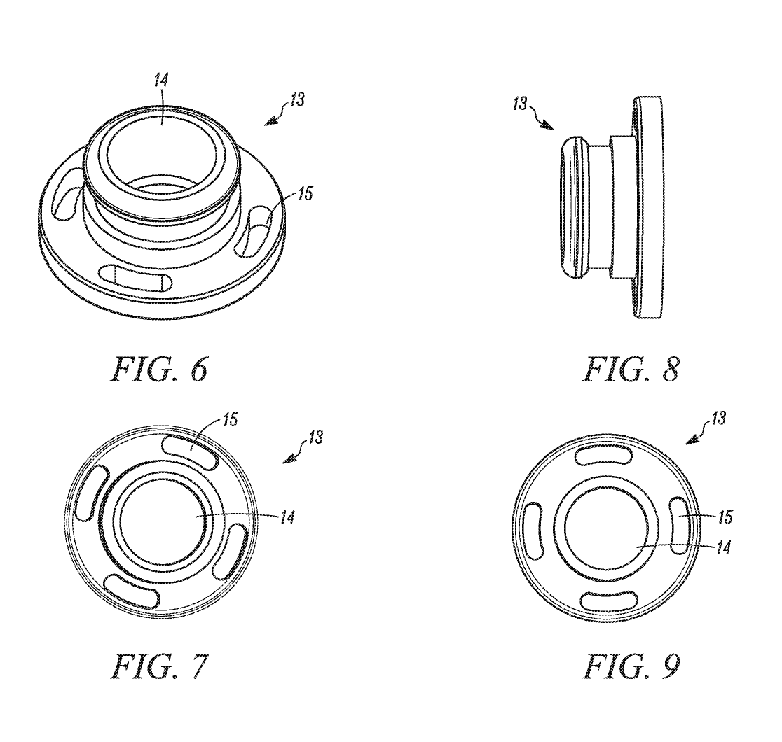

FIGS. 6-9 are various perspective view drawings illustrating an exemplary bellows adapter 13, which is identical to bellows adapter 16. The bellows adapter 13 has a first face, a second face, a main bore 14, and an outer edge. In one embodiment, the bellows adapter 13 has a one or more secondary bore 15 located around the main bore 14 of the first bellows adapter 13. In one embodiment, the one or more secondary bores 15 are each symmetrically located around the main bore 14.

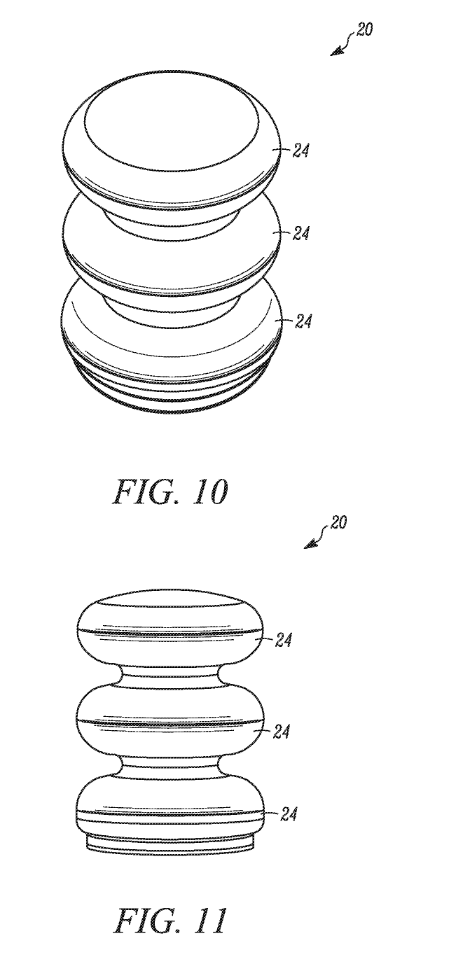

FIGS. 10-11 are various perspective view drawings illustrating a first internal bellows 20, which is identical to the second internal bellows 21. In one embodiment, the first internal bellows 20 includes a resilient flexible material. In one embodiment, the first internal bellows 20 includes a spring (not shown) in contact with an interior side of the first internal bellows 20. In one embodiment, the first internal bellows 20 includes one or more first convolutions 24.

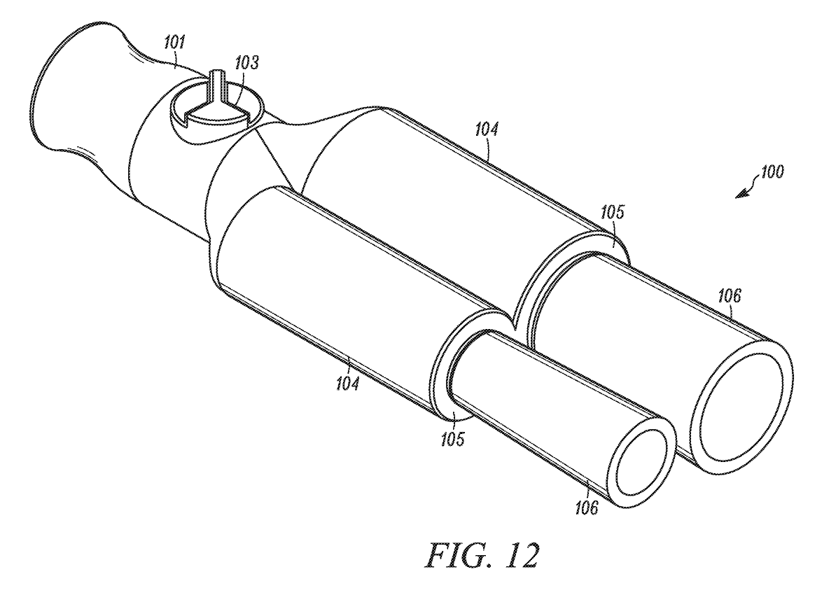

FIG. 12 is a perspective front-view drawing illustrating an exemplary game call apparatus 100 with multiple game callers. The game call apparatus 100 with multiple game callers includes a first body 101, a valve 103, two second bodies 104 and two sound-making apparatuses 106. The first body 101 has a proximal end, a distal end, and an interior opening 102 between the proximal end and the distal end. The valve 103 is contained within the first body 101 and extends through the interior opening 102. The two second bodies 104 each have a proximal end, a distal end, and an exhaust port 105 at each distal end. The proximal end of each of the two second bodies 104 is each independently coupled to and in fluid communication with the distal end of the first body 101. The valve 103 directs the passage of air between the two second bodies 104. The exhaust port 105 of each of the two second bodies 104 is each independently in fluid communication with one or more sound-making apparatuses 106. The two sound-making apparatuses 106 each independently produce one or more game calls in response to the passage of air, which causes the one or more sound-making apparatuses 106 to vibrate. In one embodiment, the game call apparatus 100 further includes a mouthpiece (not shown) coupled to the proximal end of the first body 101.

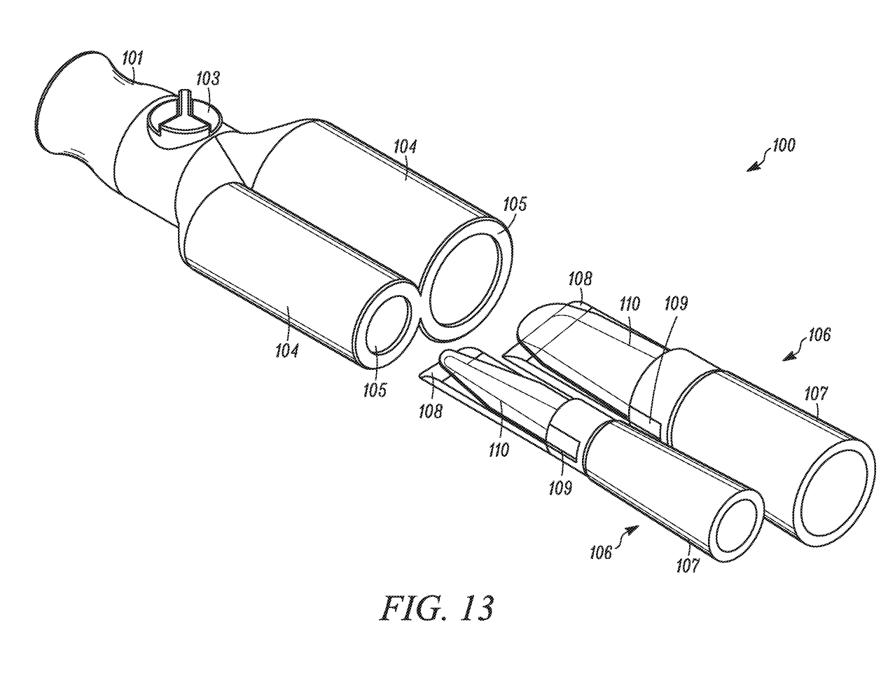

FIG. 13 is a perspective front-view drawing illustrating an exploded exemplary game call apparatus 100 with multiple game callers. In this view, the two sound-making apparatuses 106 are shown. The two sound-making apparatuses 106 each independently include an insert body 107, a tone or sound board 108, a cork or wedge 109, and one or more reeds 110.

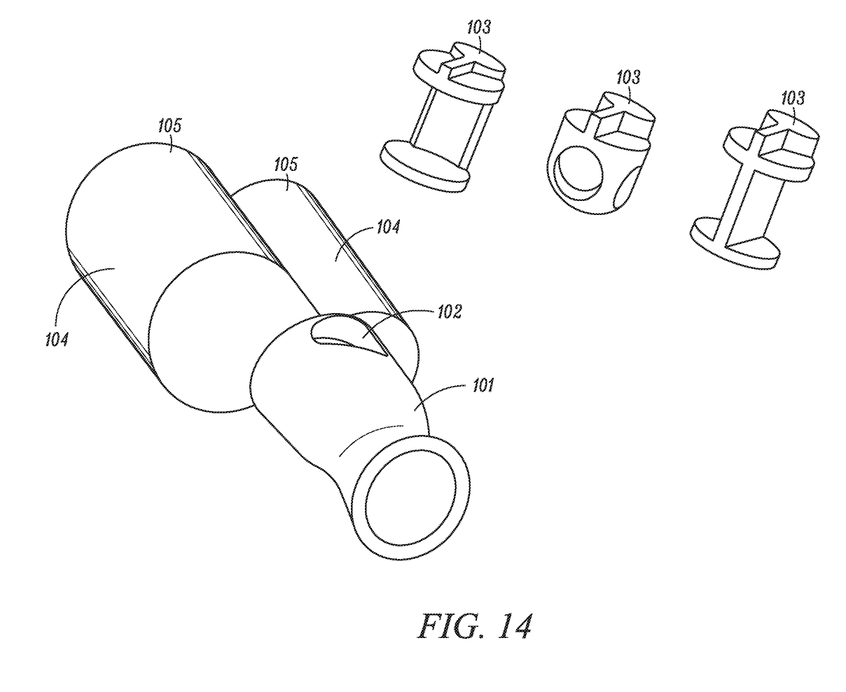

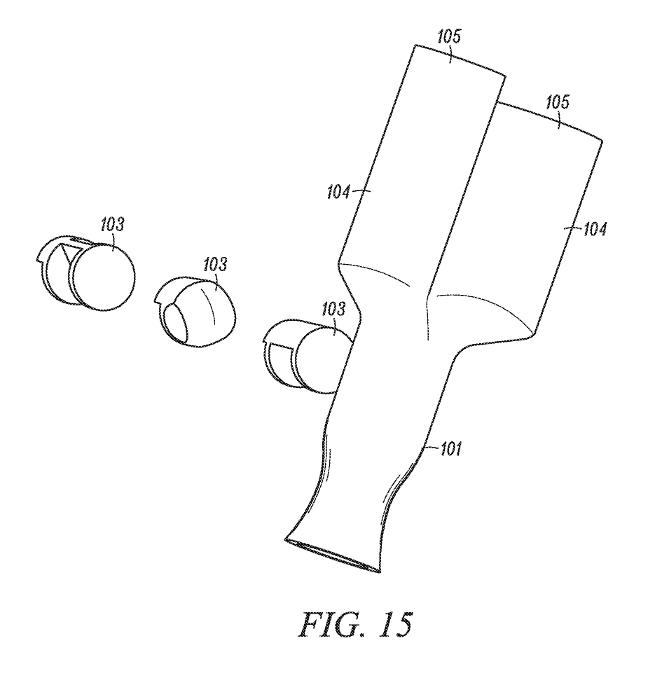

FIGS. 14-15 are various perspective-view drawings each illustrating an exemplary game call apparatus without the multiple game callers. Each game call apparatus without the multiple game callers includes a first body 101, a valve 103, and two second bodies 104. The first body 101 has a proximal end, a distal end, and an interior opening 102 between the proximal end and the distal end. The valve 103 is contained within the first body 101 and extends through the interior opening 102. The two second bodies 104 each have a proximal end, a distal end, and an exhaust port 105 at each distal end.

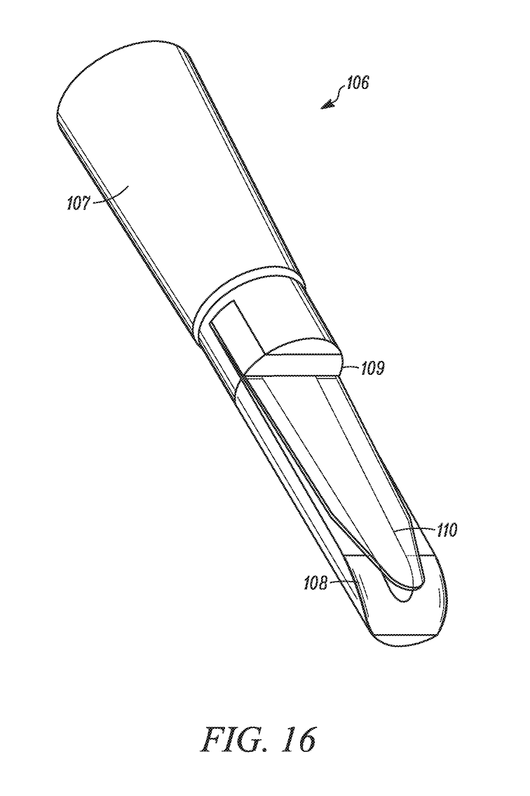

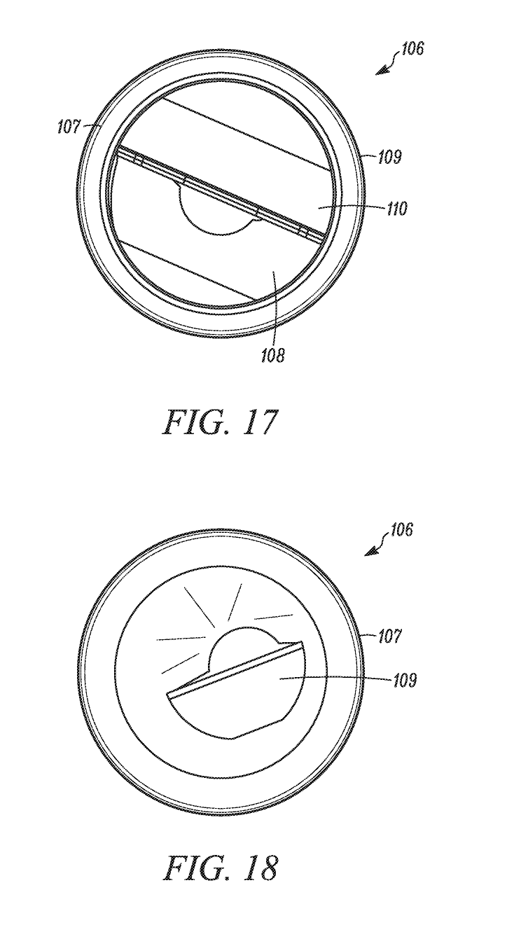

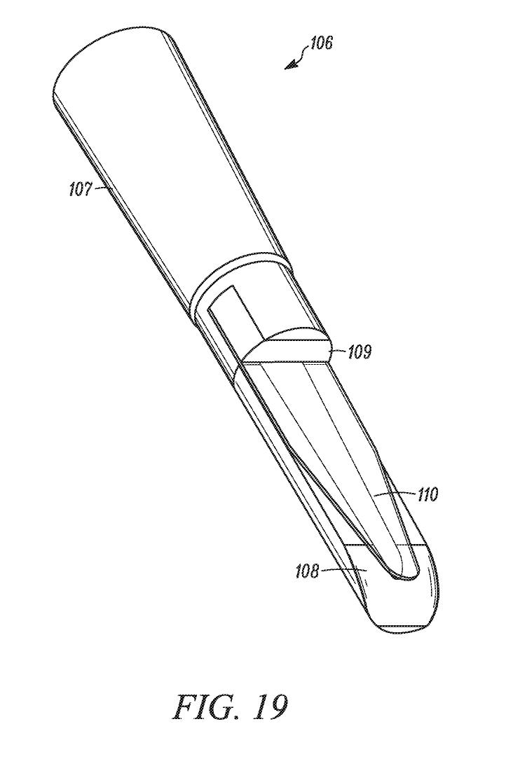

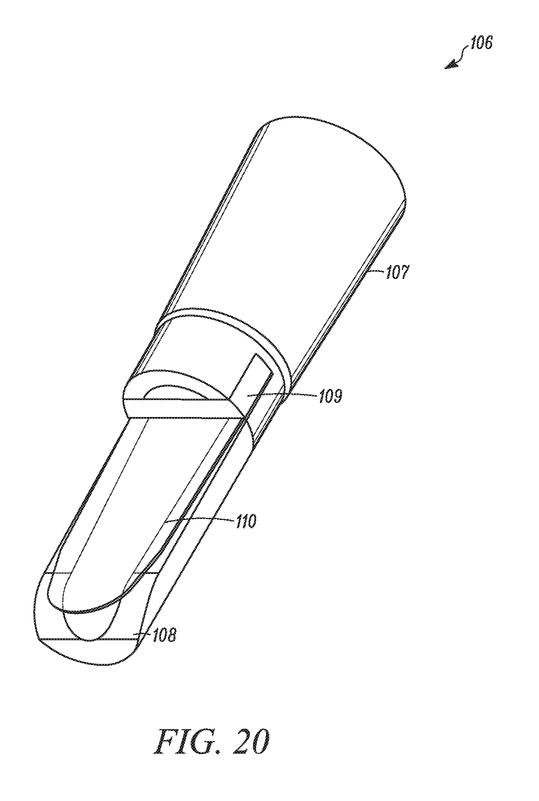

FIGS. 16-20 are various perspective-view drawings each illustrating an exemplary sound-making apparatus 106 that can be used in the exemplary game call apparatus 10 and in the exemplary game call apparatus 100 with multiple game callers. The sound-making apparatus 106 includes an insert body 107, a tone or sound board 108, a cork or wedge 109, and one or more reeds 110. The shapes of the insert body 107, a tone or sound board 108, a cork or wedge 109, and one or more reeds 110 can each vary depending upon the type of desired game call. For example, in one embodiment, the sound-making apparatus 106 in FIG. 16 is for ducks while another embodiment, the sound-making apparatus 106 in FIG. 17 is for goose. As such, the game call apparatus 100 can be used to call waterfowl, upland game, small game, big game or a combination thereof by varying each of the sound-making apparatuses 106.

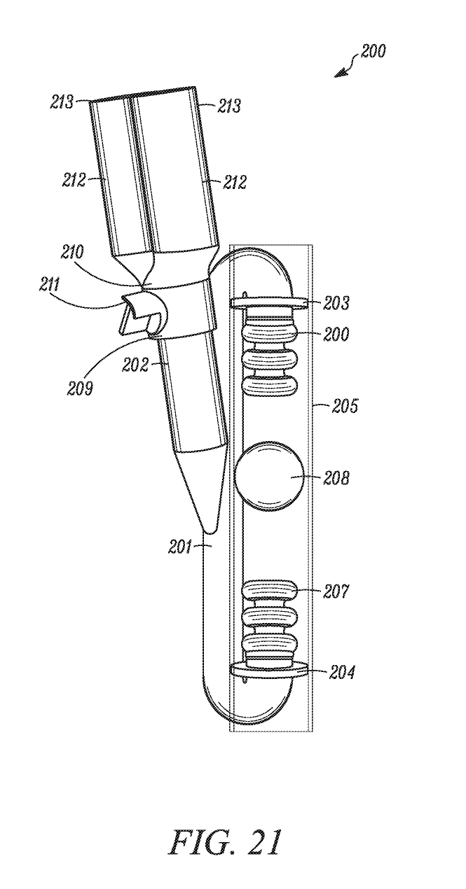

FIG. 21 is a perspective side-view drawing illustrating an exemplary game call apparatus 200 with multiple game callers. The game call apparatus 200 includes: a main tube body 201 having a proximal end, a distal end, and an exhaust port 202 between the proximal end and the distal end; a first bellows adapter 203 having a first face, a second face, a first main bore, and an first outer edge, wherein the first main bore of the first bellows adapter is coupled to the proximal end of the main tube body; a second bellows adapter 204 having a first face, a second face, a second main bore, and a second outer edge, wherein the second main bore of the second bellows adapter is coupled to the distal end of the main tube body; a bellows tube body 205 having a proximal end and a distal end, wherein the proximal end of the bellows tube body 205 is coupled to the first outer edge of the first bellows adapter 203, wherein the proximal end of the bellows tube body 205 is coupled to the second outer edge of the second bellows adapter 204, a first internal bellows 206 having an open proximal end and a closed distal end, wherein the open proximal end of the first internal bellows 206 is coupled to the proximal end of the main tube body 201 and contained within the bellows tube body 205, a second internal bellows 207 having an open proximal end and a closed distal end, wherein the open proximal end of the second internal bellows 2007 is coupled to the distal end of the main tube body 201 and contained within the bellows tube body 205; one ball 208, wherein the ball 208 is contained within the bellows tube body 205 in between the closed distal end of the first internal bellows 206 and the closed distal end of the second internal bellows 207; a second tube body 209 in fluid communication with the exhaust port 202, wherein the second tube body 209 includes: a first body 210 having a proximal end, a distal end, and an interior opening (not shown) between the proximal end and the distal end; a valve 211 contained within the first body 210 and extending through the interior opening (not shown); two or more second bodies 212 each having a proximal end, a distal end, and a second exhaust port 213 at each distal end, wherein the proximal end of each of the two or more second bodies 212 is each independently coupled to and in fluid communication with the distal end of the first body 210, wherein the valve 211 directs a passage of air between the two or more second bodies 212, wherein the second exhaust port 213 of each of the two or more second bodies 212 is each independently in fluid communication with one or more sound-making apparatuses (not shown, but identical to sound-making apparatus 23 and sound-making apparatus 106), wherein the one or more sound-making apparatuses (not shown) each independently include an insert body (not shown), a tone or sound board (not shown), a cork or wedge (not shown), and one or more reeds or discs(not shown).

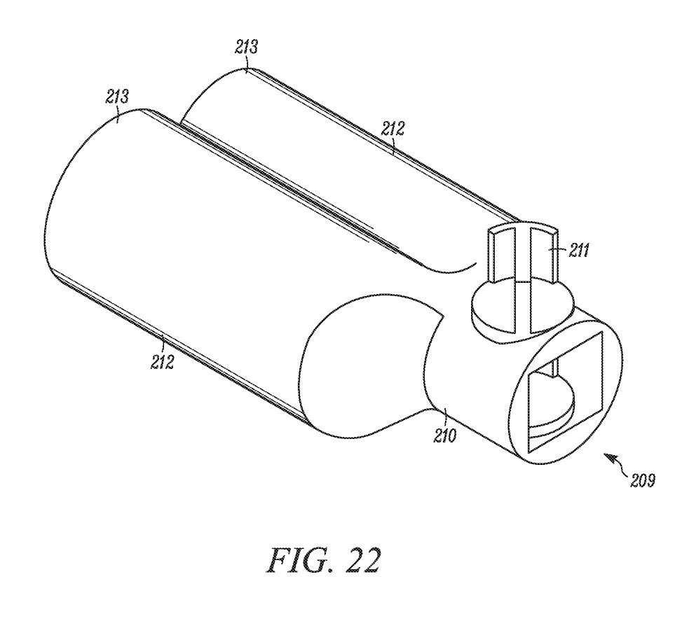

FIG. 22 is a perspective side-view drawing illustrating an exemplary second tube body 209. The second tube body 209 includes: a first body 210 having a proximal end, a distal end, and an interior opening (not shown between the proximal end and the distal end; a valve 211 contained within the first body 210 and extending through the interior opening (not shown); two or more second bodies 212 each having a proximal end, a distal end, and a second exhaust port 213 at each distal end, wherein the proximal end of each of the two or more second bodies 212 is each independently coupled to and in fluid communication with the distal end of the first body 210, wherein the valve 211 directs a passage of air between the two or more second bodies 212.

In the claims provided herein, the steps specified to be taken in a claimed method or process may be carried out in any order without departing from the principles of the invention, except when a temporal or operational sequence is explicitly defined by claim language. Recitation in a claim to the effect that first a step is performed then several other steps are performed shall be taken to mean that the first step is performed before any of the other steps, but the other steps may be performed in any sequence unless a sequence is further specified within the other steps. For example, claim elements that recite “first A, then B, C, and D, and lastly E” shall be construed to mean step A must be first, step E must be last, but steps B, C, and D may be carried out in any sequence between steps A and E and the process of that sequence will still fall within the four corners of the claim.

Furthermore, in the claims provided herein, specified steps may be carried out concurrently unless explicit claim language requires that they be carried out separately or as parts of different processing operations. For example, a claimed step of doing X and a claimed step of doing Y may be conducted simultaneously within a single operation, and the resulting process will be covered by the claim. Thus, a step of doing X, a step of doing Y, and a step of doing Z may be conducted simultaneously within a single process step, or in two separate process steps, or in three separate process steps, and that process will still fall within the four corners of a claim that recites those three steps.

Similarly, except as explicitly required by claim language, a single substance or component may meet more than a single functional requirement, provided that the single substance or component fulfills the more than one functional requirement as specified by claim language,

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention.

Applicant reserves the right to physically incorporate into this specification any and all materials and information from any such patents, applications, publications, scientific articles, web sites, electronically available information, and other referenced materials or documents. Applicant reserves the right to physically incorporate into any part of this document, including any part of the written description, the claims referred to above including but not limited to any original claims.

What is claimed is:

1. A game call apparatus comprising:
a main tube body having a proximal end, a distal end, and one or more exhaust ports each independently between the proximal end and the distal end;
a first bellows adapter having a first face, a second face, a first main bore, and a first outer edge,
wherein the first main bore of the first bellows adapter is coupled to the proximal end of the main tube body;
a second bellows adapter having a first face, a second face, a second main bore, and a second outer edge,
wherein the second main bore of the second bellows adapter is coupled to the distal end of the main tube body;
a bellows tube body having a proximal end and a distal end,
wherein the proximal end of the bellows tube body is coupled to the first outer edge of the first bellows adapter,
wherein the proximal end of the bellows tube body is coupled to the second outer edge of the second bellows adapter,
a first internal bellows having an open proximal end and a closed distal end,
wherein the open proximal end of the first internal bellows is coupled to the proximal end of the main tube body and contained within the bellows tube body,
a second internal bellows having an open proximal end and a closed distal end,
wherein the open proximal end of the second internal bellows is coupled to the distal end of the main tube body and contained within the bellows tube body;
one or more balls,
wherein the one or more balls are contained within the bellows tube body in between the closed distal end of the first internal bellows and the closed distal end of the second internal bellows;
one or more sound-making apparatuses each independently in fluid communication with the one or more exhaust ports,
wherein the one or more sound-making apparatuses each independently produces a game call in response to a passage of air caused by a movement of the one or more balls against the closed distal end of the first internal bellows, the closed distal end of the second internal bellows, or a combination thereof, and
wherein the passage of air causes the one or more sound-making apparatuses each independently to vibrate.

2. The game call apparatus of claim 1, wherein the first main bore is centered on the first bellows adapter.

3. The game call apparatus of claim 1, further comprising one or more first secondary bores located around the first main bore of the first bellows adapter.

4. The game call apparatus of claim 3, wherein the one or more first secondary bores are each symmetrically located around the first main bore.

5. The game call apparatus of claim 1, wherein 1 e second main bore is centered on the second bellows adapter.

6. The game call apparatus of claim 1, further comprising one or more second secondary bores located around the second main bore of the second bellows adapter.

7. The game call apparatus of claim 6, wherein the one or more second secondary bores are each symmetrically located around the second main bore.

8. The game call apparatus of claim 1, wherein the one or more sound-making apparatuses each independently comprise an insert body, a tone or sound board, a cork or wedge, and one or more reeds or discs.

9. A game call apparatus comprising:
a main tubular body having a proximal end, a distal end, and an exhaust port between the proximal end and the distal end;
a first bellows adapter having a first face, a second face, a first main bore centered on the first bellows adapter, one or more first secondary bores each symmetrically located around the first main bore, and an first outer edge,
wherein the first main bore of the first bellows adapter is coupled to the proximal end of the main tubular body;
a second bellows adapter having a first face, a second face, a second main bore centered on the second bellows adapter, one or more second secondary bores each symmetrically located around the second main bore, and a second outer edge,
wherein the second main bore of the second bellows adapter is coupled to the distal end of the main tubular body;
a bellows tubular body having a proximal end and a distal end,
wherein the proximal end of the bellows tubular body is coupled to the first outer edge of the first bellows adapter,
wherein the proximal end of the bellows tubular body is coupled to the second outer edge of the second bellows adapter,
a first internal bellows having an open proximal end and a closed distal end,
wherein the open proximal end of the first internal bellows is coupled to the proximal end of the main tubular body and contained within the bellows tubular body;
a second internal bellows having an open proximal end and a closed distal end,
wherein the open proximal end of the second internal bellows is coupled to the distal end of the main tubular body and contained within the bellows tubular body;
one or more balls,
wherein the one or more balls are contained within the bellows tubular body in between the closed distal end of the first internal bellows and the closed distal end of the second internal bellows;
a sound-making apparatus in fluid communication with the exhaust port,
wherein the sound-making apparatus comprises an insert body, a tone or sound board, a cork or wedge, and one or more reeds or discs,
wherein the sound-making apparatus produces a game call in response to a passage of air caused by a movement of the one or more balls against the closed distal end of the first internal bellows, the closed distal end of the second internal bellows, or a combination thereof, and
wherein the passage of air causes the sound-making apparatus to vibrate.

10. A game call apparatus with multiple game callers comprising:
a first body having a proximal end, a distal end, and an interior opening between the proximal end and the distal end;
a valve contained within the first body and extending through the interior opening;
two or more second bodies each having a proximal end, a distal end, and an exhaust port at each distal end,
wherein the proximal end of each of the two or more second bodies is each independently coupled to and in fluid communication with the distal end of the first body,
wherein the valve directs a passage of air between the two or more second bodies,
wherein the exhaust port of each of the two or more second bodies is each independently in fluid communication with one or more sound-making apparatuses, and
wherein one or more sound-making apparatuses each independently produce one or more game calls in response to the passage of air, which causes the one or more sound-making apparatuses to vibrate.

11. The game call apparatus of claim 10, wherein the game call apparatus is used to call waterfowl, upland game, small game, big game or a combination thereof.

12. The game call apparatus of claim 10, wherein the one or more sound-making apparatuses each independently comprise an insert body, a tone or sound board, a cork or wedge, and one or more reeds or discs.

13. The game call apparatus of claim 10, further comprising a mouthpiece coupled to the proximal end of the first body.
